(19) United States
(12) Patent Application Publication
(10) Pub. No.: US 2021/0348592 A1
(43) Pub. Date: Nov. 11, 2021

(54) COMPACT VERTICAL AXIS TURBINE

(71) Applicant: Headwind Technologies Ltd., Vancouver (CA)

(72) Inventor: Glenn KYLLONEN, Vernon (CA)

(21) Appl. No.: 16/868,271

(22) Filed: May 6, 2020

(51) Int. Cl. F03D 3/00; F03D 15/00; F03D 3/06

(52) U.S. Cl. CPC F03D 3/005; F03D 3/062; F03D 15/00

(57) ABSTRACT

Disclosed are vertical axis turbines comprising: a turbine shaft; a plurality of helicoidal blades mounted on the turbine shaft, each blade comprising a front face and a rear face; and a plurality of venturis, each venturi comprising a channel extending through each of the plurality of blades from the front face thereof to the rear face thereof.

### TECHNICAL FIELD

The present disclosure relates generally to turbines for renewable energy sources and in particular to vertical axis turbines capable of self-starting and generating power in low fluid flow conditions.

### BACKGROUND

Renewable energy is a rapidly expanding market, especially in view of the effects on the global climate resulting from the use of non-renewable energy sources such as fossil fuels including coal, petroleum, and natural gas. Common renewable energy sources include, for example, geothermal, hydropower, solar energy, and wind energy.

Of the various types of renewable energy sources, wind energy may be particularly advantageous, as it may be captured almost anywhere on the planet and, once the equipment used to convert the wind energy to electricity is set up, the costs of operating and maintaining the equipment is relatively low compared to that of fossil fuels.

Wind energy is conventionally converted to electricity by way of a wind turbine. The two most common types of wind turbines used are horizontal axis wind turbines (HAWTs) and vertical axis wind turbines (VAWTs). HAWTs generally have a plurality of blades that rotate about an axis that is parallel with the ground. The blades of the HAWT must be faced into the wind in order to capture its kinetic energy. VAWTs generally include a plurality of elements (e.g. blades, scoops, or the like) that rotate about an axis that is perpendicular to the ground. Many types of VAWTs, unlike HAWTs, may be omni-directional in that its elements do not need to be faced into the wind in order to capture the kinetic energy thereof.

There are a number of different types of VAWTs. Conventional VAWTs are typically Savonius-type or Darrieus-type wind turbines. Savonius-type turbines may be drag-style turbines that use a plurality of barrel-shaped scoops overlapping a central vertical shaft. Due to the curvature of the scoops, the scoops experience less drag when moving against the wind than when moving with the wind. This drag differential causes the turbine to spin. In contrast, Darrieus-type turbines may be egg beater-style turbines that include a number of curved blades mounted on a vertical rotating shaft or frame. The curved blades are angled in such a way that the wind is forced therebetween to rotate the vertical shaft or frame.

Generally, Savonius-type turbines may be less efficient than Darrieus-type turbines but are able to capture wind at lower heights. As well, while Darrieus-type turbines may be more efficient than Savonius-type turbines, they may not be capable of self-starting and may require greater elevation and higher winds to operate.

Further, hydropower may also be a particularly advantageous renewable energy source, as it may allow for continuous, predictable energy production without releasing a substantial amount of carbon into the atmosphere. As well, due to the availability of masses of water, hydropower may also be captured in many locations across the planet. Hydropower may be captured in a variety of ways. For example, in some instances, axial turbines that operate in a similar manner to the HAWTs and VAWTs described above may be used to convert kinetic energy from water to rotational energy.

### SUMMARY

Embodiments of the present disclosure generally relate to vertical axis turbines. The vertical access turbines may be used to generate electricity using the kinetic energy of a fluid such as air or water.

Some aspects relate to vertical axis turbines comprising: a turbine shaft; a plurality of helicoidal blades mounted on the turbine shaft, each blade comprising a front face and a rear face; and a plurality of venturis, each venturi comprising a channel extending through each of the plurality of blades from the front face thereof to the rear face thereof.

Advantageously, the vertical axis turbines of the present disclosure may be used in a variety of fluid applications. For example, the vertical axis turbines may be used to generate electricity using kinetic energy provided by wind or water. Further, the vertical axis turbines of the present disclosure may also be capable of self-starting such that an external power source may not be required to begin operation, even in low-wind or low-current conditions. As well, the vertical axis turbines of the present disclosure may be relatively small in size, which, in combination with the capability of self-starting, may be especially advantageous for applications such as camping or RVing, where ease of transport may be particularly important.

Further, in regards to wind applications, the vertical axis turbines may also advantageously produce less noise than that of propeller type turbines. The capability of quiet operation, as well as in in low-wind conditions, may be particularly advantageous for operation in urban environments. Also in relation to wind applications, the vertical axis turbines of the present disclosure may also be shaped such that they are capable of shedding precipitation (e.g. rain, snow, etc.) during operation. Further, the construction of the blades of the vertical axis turbines of the present disclosure may also allow for the capturing of wind at relatively low heights.

Furthermore, the shape of and materials used to construct the vertical axis turbines of the present disclosure may advantageously allow the turbine to operate even in relatively high-wind or high-current conditions without needing to be furled. As well, the shape of and materials used to construct the vertical axis turbines of the present disclosure may also allow the turbine to operate in a wildlife-friendly manner (e.g. without harming birds, bats, fish, etc.).

Further advantages will become apparent to those of ordinary skill in the art upon reading the present disclosure.

### BRIEF DESCRIPTION OF THE FIGURES

The embodiments of the present disclosure will be described with reference to the following drawings in which:

FIG. 1 is a perspective view of a vertical axis turbine in an embodiment of the present disclosure;

FIG. 2 is a top view of a vertical axis turbine in an embodiment of the present disclosure;

FIG. 3 is a side view of a vertical axis turbine in an embodiment of the present disclosure;

FIG. 4 is a perspective view of a blade of a vertical axis turbine in an embodiment of the present disclosure;

FIG. 5 is a top view of the blade depicted in FIG. 4;

FIG. 6 is a bottom view of the blade depicted in FIG. 4; and

FIG. 7 is an exploded view of a vertical axis turbine in an embodiment of the present disclosure.

### DETAILED DESCRIPTION

The embodiments of the present disclosure generally relate to vertical axis turbines. More specifically, the embodiments of the present disclosure relate to vertical axis turbines capable of self-starting and operating in low fluid flow conditions.

As used herein, “turbine” is intended to refer to a device that captures the kinetic energy of a fluid (e.g. wind or water) and converts it to rotational energy. The rotational energy provided by the turbine may then be converted into electrical energy using an electrical generator. Generally, turbines comprise one or more elements that are caused by the fluid to rotate about an axis in order to drive the electrical generator. The one or more elements may be, for example, blades, scoops, or the like. Further, as used herein “vertical axis” is intended to mean that the axes of the rotation of the turbines are perpendicular to the ground.

As used herein, the expression “self-starting” is intended to mean that the turbines may start operation (i.e. begin rotation) using only the kinetic energy provided by a fluid (e.g. wind or water). That is, a self-starting turbine may not require an external power source to initiate rotation.

As used herein, the expression “low fluid flow conditions” is intended to encompass low-wind and low-current conditions. “Low-wind conditions” is intended to refer to winds having speeds of about 1.5 km/hr to about 12 km/hr. “Low-current conditions” is similarly intended to refer to liquid flowing at about 1.5 km/hr to about 12 km/hr.

Reference will now be made in detail to example embodiments of the present disclosure, wherein numerals refer to like components, examples of which are illustrated in the accompanying figures.

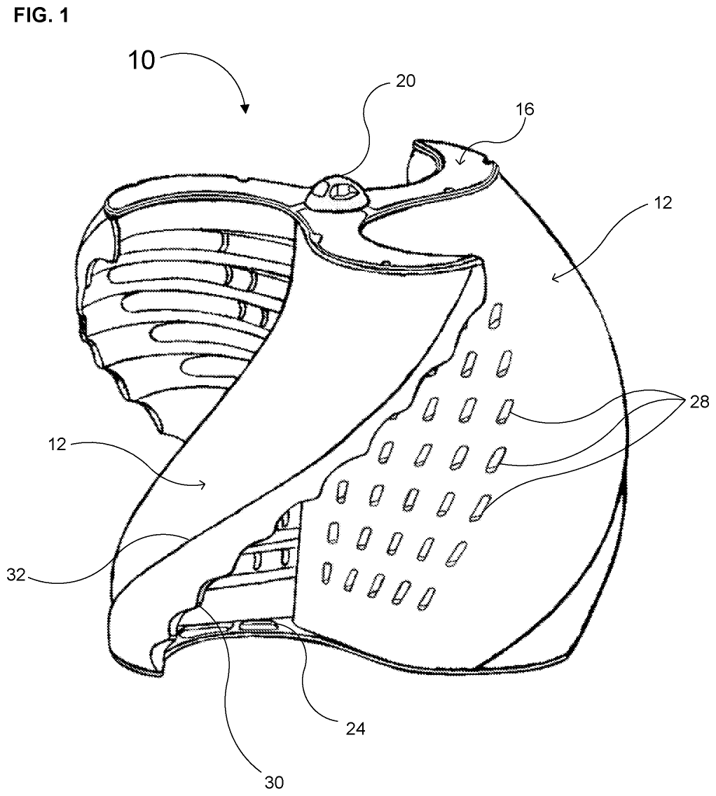

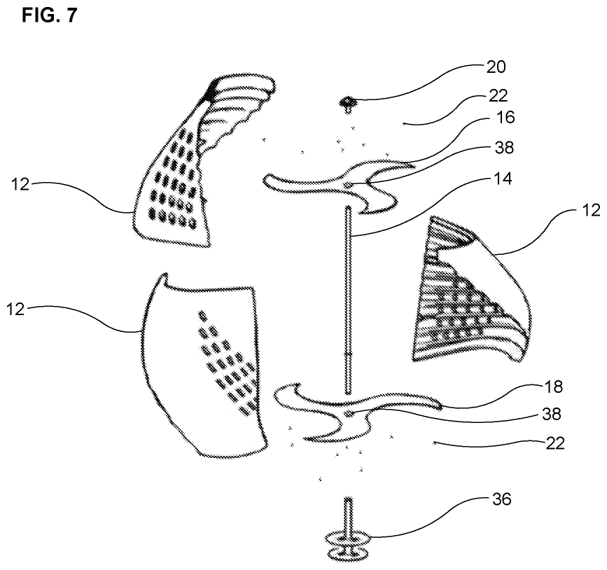

Referring to FIG. 1, there is depicted an example embodiment of the present disclosure, namely a vertical axis turbine 10. According to an embodiment, the vertical axis turbine 10 may comprise a plurality of blades 12 located around a central turbine shaft 14 extending therebetween (see FIG. 7). The turbine shaft 14 acts as the vertical axis of the turbine 10. In one aspect, the turbine shaft 14 may have a diameter of about 15 mm to about 80 mm. The diameter of the turbine shaft 14 may be selected based on the height and weight of the plurality of blades 12. The turbine shaft 14 may be a solid shaft or may have an internal throughbore. In some aspects, the turbine shaft comprises an inner drive shaft (not shown) rotatably contained within the internal throughbore. The turbine shaft 14 and, if present, the inner drive shaft, may be independently made of a durable, lightweight material such as, for example, a metal, a metal alloy, a polymer, or carbon fiber. In particular aspect, the turbine shaft 14 is formed of carbon fiber.

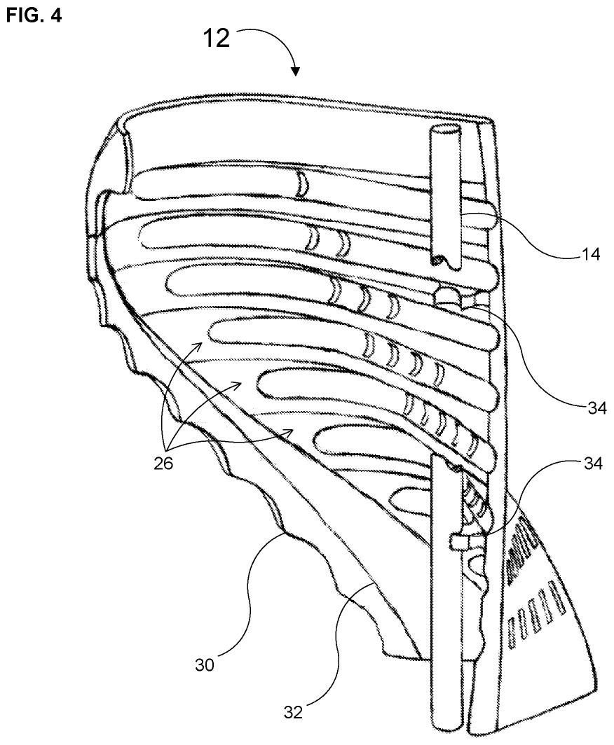

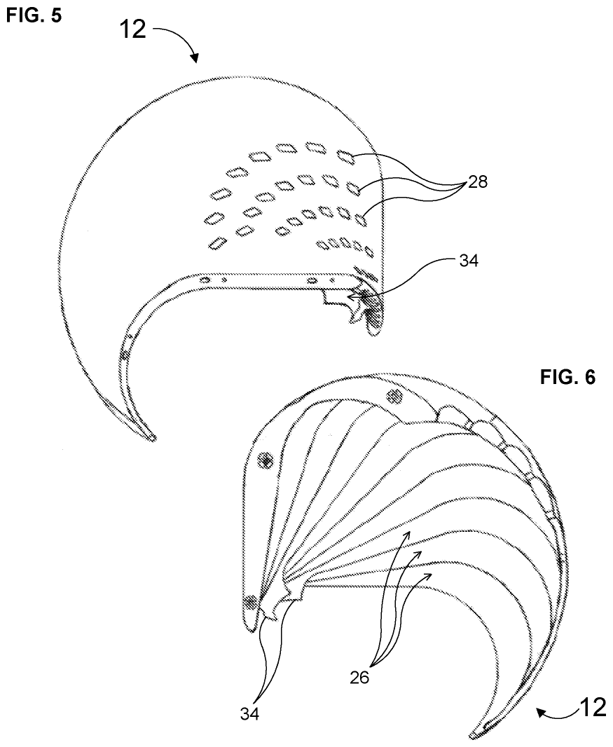

In the example embodiment, the plurality of blades 12 comprises three blades. However, in some aspects, the plurality of blades 12 may comprise 2, 4, or more blades 12. In an aspect, each of the plurality of blades 12 may be twisted in shape. In a particular aspect, each of the blades 12 may be generally helicoidal, such as shown in FIGS. 4 to 6. In some aspects, the plurality of blades may be formed of a durable, lightweight material such as a metal, a metal alloy, a polymer, or carbon fiber. In a particular aspect, the plurality of blades 12 are formed of polyethylene terephthalate glycol-modified (PETG).

In a further aspect, each of the blades 12 may comprise a front face (i.e. the side that turns into the flow of fluid) and a rear face (i.e. the side that turns away from the flow of fluid). In some aspects, the front face of each of the plurality of blades 12 may have a smooth surface. As used herein, “smooth surface” is intended to mean that the surface is free from recesses and/or protrusions that may substantially increase the surface area of the face of the blades 12. In such aspects, the smooth surface may reduce the drag of the blades 12 during operation of the turbine 10. In a further aspect, the rear face may comprise a non-smooth surface. In some aspects, the blades may have a height of about 350 mm to about 1550 mm. In a further aspect, each of the blades 12 may have a width such that the total width of the turbine 10 is about 40 mm to about 210 mm. In some aspects, the total capture area provided by the plurality of blades 12 is about 0.15 m² to about 3.0 m².

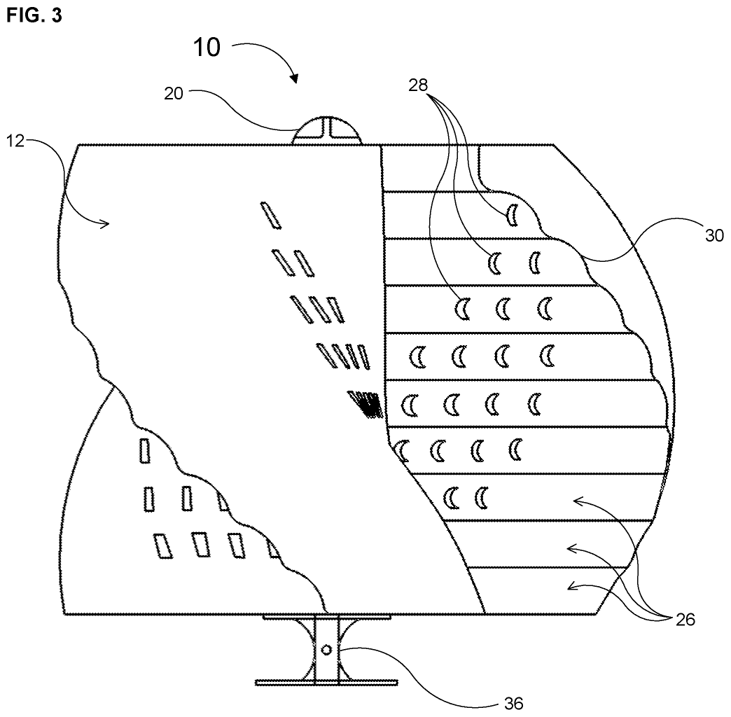

According to one embodiment, each of the plurality of blades 12 may be divided into a plurality of sections 26, as illustrated in FIGS. 3 and 6. In one aspect, the plurality of sections 26 are horizontal sections that are stacked to form each of the plurality of blades 12. In such aspects, the number and height of sections 26 may be independently selected based on the desired overall height of each of the plurality of blades 12. In one aspect, each of the plurality of blades are divided into 10 sections 26. In a particular aspect, the sections 26 are equal in height. In an additional aspect, each of the plurality of sections 26 are shaped such that they provide blades that are twisted in shape. In a particular aspect, each of the sections 26 are generally hook-shaped in that each section 26 has a straight portion and a curved portion extending from one end of the straight portion. In a particular aspect, the sections 26 may be arranged such that an end of the straight portion opposite the curved portion may be adjacent the center of the turbine 10 (e.g. adjacent the turbine shaft 14). In a yet further aspect, the thickness of each of the sections 26 may independently vary from one end of the section to the other. For example, in aspects where the sections 26 are hook-shaped, the thickness may progressively increase across the straight portion to about the point from which the curved portion extends, at which point the thickness of the section 26 may progressively decrease. In some aspects, the thickness may progressively increase and subsequently decrease again, after the progressive decrease, as illustrated in FIG. 6.

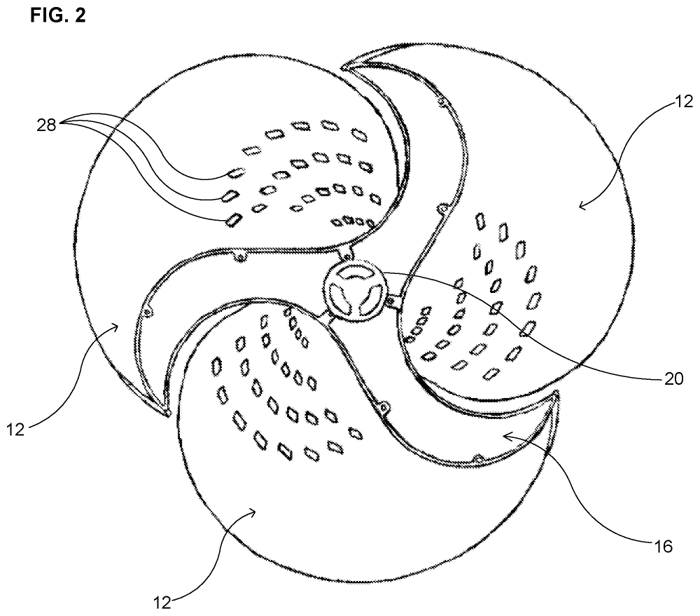

Further, in some aspects, the plurality of sections 26 may form a step-like arrangement (i.e. a series of steps) on the rear face of the plurality of blades 12. In such aspects, each section may be progressively rotated about a point located at the center of the turbine 10 (e.g. the center of the turbine shaft 14), relative to a section located immediately therebelow. The angle of rotation may be clockwise or counterclockwise. Such aspects may produce blades 12 that each wrap around the vertical axis of the turbine 10. For example, in some aspects, each of the plurality of blades 12 may comprise an inner edge that wraps around the turbine shaft 14 (see, for example, FIG. 4). In such aspects, the length of each of the sections 26 may vary such that a continuous outer edge (i.e. the edge opposite the inner edge) is formed, as illustrated in FIG. 2. In a further aspect, each of the sections 26 is rotated about 5° to about 10° relative to a below section. In a particular aspect, each of the sections 26 is rotated about 9° relative to a below section. As will be appreciated, the degree to which each section is rotated may be selected based on the desired angle of attack of the plurality of blades 12. In a further aspect, each of the plurality of sections 26 may be rotated such that a top edge and a bottom edge of each of the blades 12 are rotated about 50° to about 120° relative to each other. In a particular aspect, the top edge and the bottom edge are rotated about 90° relative to each other.

According to a further embodiment, one or more of the plurality of sections 26 may be scalloped on the side that forms the rear face of the blades 12. In an aspect, the scalloping may extend across the length of the side the sections 26 forming the rear face of the blades 12, as illustrated in FIG. 4. In a particular aspect, the scalloping extends across about 70% to about 90% of the length of the sections 26. In a further aspect, the top-most and bottom-most of the sections 26 are free from scalloping. The scalloping may serve to further increase the surface area of the rear face of the blades 12. As well, the scalloping may provide a path for the fluid to flow through the center of the turbine 10 in order to drive the blades 12 during operation. Further, in some aspects, the surfaces of the each of the sections 26 may be sloped in order allow precipitation (e.g. rain, snow, etc.) to run off during operation of the turbine 10 as a wind turbine.

According to a further embodiment, the vertical axis turbine 10 may comprise a plurality of venturis 28 in each of the plurality of blades 12. The plurality of venturis 28 may extend from the front face of the blades 12 through to the rear face thereof. In an aspect, the venturis 28 may comprise generally circular or generally rectangular openings. In a further aspect, each of the plurality of venturis 28 may be straight in that they do not curve relative to their distance from the central turbine shaft 14. That is, each of the plurality of venturis 28 may comprise a straight channel extending from the front face of plurality of blades 12 to the rear face thereof. Further, in some aspects, each of the plurality of venturis 28 may have a height that decreases from the front face of the blades 12 to the rear face thereof. In such aspects, the venturis 28 may comprise a frustum-shaped channel. In some aspects, the plurality of venturis 28 may comprise up to about 50 venturis. In a particular aspect, the plurality of venturis may comprise 30 venturis. In an aspect, the plurality of venturis 28 are evenly distributed within rows across the plurality of blades 12, with each row comprising one or more venturis 28.

Further, in some aspects, the plurality of venturis 28 may extend through the blades 12 at an angle. In such aspects, the venturis 28 may extend through the blades 12 at an angle of about 20° to about 60° relative to the rear face of the blades 12. In a further aspect, the angle at which the venturis 28 extend through the blades 20 may progressively increase or decrease across the row of venturis 28. For example, the angle may increase or decrease by about 2° to about 10° from one venturi to the next, across the row of venturis 28. In one aspect, the angle at which the venturis 28 extend through the blades 12 may progressively decrease from the outermost venturi (i.e. the venturi furthest away from the center of the turbine 10) to the innermost venturi (i.e. the closest to the center of the turbine 10). In a particular aspect, the angle at which each venturi extends through the blades 12 may decrease by about 5° from one venturi to the next. In a further particular aspect, the outermost venturi may extend through the blades at an angle of about 50°.

In a further aspect, the plurality of sections 26 may each comprise one or more of the venturis 28. In such aspects, one or more of the sections 26 may comprise the rows of venturis 28 previously described herein. However, in another aspect, the top-most and bottom-most sections do not comprise any of the venturis 28. As well, in aspects where one or more of the sections 26 are scalloped, the venturis 28 may be located within the scalloping. Further, in some aspects, the number of venturis 28 per each of the sections 26 may progressively increase from one section to the next. For example, and as illustrated in FIG. 3, the number of venturis 28 per each of the sections 26 may increase relative to a section located immediately thereabove. However, as will be appreciated, the number of venturis 28 per each of the sections 26 may also increase in the opposite direction (i.e. relative to a section located immediately therebelow). In some aspects, there may be a maximum number of venturis 28 per each of the sections 26. In such aspects, once the maximum number of venturis 28 per each of the sections 26 is attained, the number of venturis 28 per each of the sections 26 may be maintained for each following section, or, alternatively, the number of venturis 28 per each of the sections 26 may progressively decrease thereafter. For example, such as in the illustrated embodiment, the number of venturis 28 per each of the sections 26 may progressively increases to a maximum of 5, at which point the number of venturis 28 per each of the sections 26 may be maintained for each subsequent section.

The plurality of venturis 28 may allow fluid (e.g. air or water) to flow through the plurality of blades 12 during operation. As well, the fluid flowing through the venturis 28 may increase in velocity as the plurality of blades 12 rotate. As a result of the air or water coming out of the venturis 28 at the rear face of the blades 12 being faster than that at the front face of the blades 12, there may be produced a negative pressure at the front face, which may facilitate the rotation of the blades 12. The plurality of venturis 28 may facilitate the rotation of the blades 12 in low-wind and low-current conditions.

According to a further embodiment, each of the plurality of blades 12 may comprise additional features that may improve the aerodynamics thereof. For example, each of the blades 12 may comprise a trailing edge 30 extending generally perpendicularly from the outermost edge of each of the blades 12 (see, for example, FIGS. 1, 3, and 4). In some aspects, the trailing edge 30 may be waved, such as in the illustrated example. In such aspects, the crests of the waves may be generally in line with boundaries between the sections 26 and the troughs may be generally in line with a middle of portion of the sections 26, as illustrated in FIG. 3. In further aspects, each of the blades 12 may comprise a shear line 32 extending along a boundary where the trailing edge 30 and the front face of each of the blades 12 meet, as illustrated in FIGS. 1 and 4.

According to a yet further embodiment, the plurality of blades 12 may be mounted on the central turbine shaft 14. In one aspect, the plurality of blades 12 are affixed to the turbine shaft 14 and the turbine shaft 14 acts as a drive shaft to deliver the rotational energy to an electrical generator (not shown). In another aspect, the plurality of blades 14 may be mounted on the turbine shaft 14 and affixed to the inner drive shaft previously described herein. In such aspects, the blades 12 and the inner drive shaft rotate relative to the turbine shaft 14, and the inner drive shaft delivers the rotational energy to the electrical generator. The turbine shaft 14 or, if present, the inner drive shaft may deliver the rotational energy to the electrical generator using any suitable method. A person of ordinary skill in the art is familiar configurations to for the production of electrical energy from turbines. For example, the turbine 10 may be mounted onto the electrical generator by way of an adaptor 36, as illustrated in FIGS. 3 and 7.

According to a further embodiment, each of the plurality of blades 12 comprises a plurality of interlocking arbors 34 (see FIG. 4) extending from the rear face thereof for receiving the turbine shaft 14. The arbors 34 may be located at the same height on each of the blades 12 and may be complementarily shaped such that they interlock with each other around the circumference of the turbine shaft 14. The interlocking of the arbors 34 may allow for the mounting of the plurality of the blades 12 on the turbine shaft 14. In a particular aspect, each of the blades 12 has 2 interlocking arbors 34.

According to another embodiment, the plurality of blades 12 may be joined such they rotate together. In a first aspect, the blades 12 may be joined by way of mounting on one or more plates. The one or more plates may be shaped such that they conform to edges of the blades 12. In the illustrated example, the blades 12 are mounted on two plates, namely an upper plate 16 and a lower plate 18. In aspects where the blades 12 are mounted on more than one plate, such as in the illustrated example, the plates may be rotated relative to each other, based on degree of rotation of the top edge of the blades 12 relative to the bottom edge of the blades 12.

The plurality of blades 12 may be mounted on the one or more plates using any suitable method. For example, in one aspect, the blades 12 may be mounted on the one or more plates by way of fasteners, such as screws 22 illustrated in FIG. 7, or, depending on the materials used to form the one or more plates and the plurality of blades 12, by way of fusing or welding. The one or more plates may be formed of any suitable (e.g. lightweight and durable) material. For example, the one or more plates may be independently made of a metal, a metal alloy, a polymer, or carbon fiber. In a particular aspect, the one or more plates may be formed of PETG. As well, in some aspects, the one or more plates may comprise cut-outs (e.g. cut-outs 24 in the lower plate 18 illustrated in FIG. 1). The cut-outs 24 may reduce the weight of the one or more plates. As well, when the turbine 10 is used for wind applications, the cut-outs 24 may prevent snow and/or water from collecting on the surface of the lower plate 18 and, when used in colder climates, subsequently freezing thereon. It is noted that, when the turbine 10 is used for water applications, the one or more plates may be free from cut-outs 24.

Further, the one or more plates, in addition to facilitating the joining of the blades 12, may also act to secure the blades 12 to the turbine shaft 14. For example, such as in the illustrated embodiment, each of the upper plate 16 and the lower plate 18 may have an orifice 38 located at a central portion thereof for receiving the turbine shaft 14 therethrough (see FIG. 7). In such aspects, the orifice 38 of the upper plate 16 may be configured to receive an upper cap 20. The upper cap 20 may be threaded into the orifice 38 of the upper plate 16 and may comprise a recess for receiving the turbine shaft 14 and securing the upper plate 16 thereon.

Further, as previously discussed herein, the plurality of blades 12 may rotate with the turbine shaft 14 or, if present, may instead rotate with the inner drive shaft, relative to the turbine shaft 14. In aspects where the plurality of blades 12 rotate with the turbine shaft 14, the upper cap 20 may fixedly receive the turbine shaft 14. For example, the upper cap 20 may thread onto the turbine shaft 14 or, alternatively, the upper cap 20 and the turbine shaft 14 may have complementary recesses and protrusions that prevent them from rotating relative to each other. In aspects where the plurality of blades 12 rotate with the inner drive shaft, relative to the turbine shaft 14, the upper cap 20 may, for example, be configured to rotate within the internal throughbore of the turbine shaft 14 and may fixedly receive the inner drive shaft using the same configurations described in relation to the turbine shaft 14.

In the illustrated example, the plurality of blades 12 are mounted on the upper plate 16 and the lower plate 18. However, as previously indicated herein, there may, in some aspects, be only a single plate present. That is, in such aspects, the plurality of blades 12 may be joined by a single upper plate or a single lower plate. In aspects where the blades 12 are joined by way of a single upper plate, the single upper plate may be configured in the same manner as described above in relation to upper plate 16 in order to secure the blades 12 to the turbine shaft 14. In aspects where the blades 12 are joined by way of a single lower plate, the single lower plate may be supported on the turbine shaft 14, for example, by one or more protrusions extending from a circumference thereof. The single lower plate may then be affixed to the turbine shaft 14 by way, for example, of threading, or complementary protrusions and recesses in the turbine shaft 14 and the orifice 38, such that the blades 12 may rotate with the turbine shaft 14. Alternatively, in some aspects, the single lower plate may engage with the turbine shaft 14 or, if present, the inner drive shaft, by way of a lower cap (not shown), the lower cap being configured in the same manner as the upper cap 20. In such aspects, the turbine shaft 14 may not extend through the single lower plate and between the plurality of blades 12.

The turbine 10, once assembled, may have a total weight of about 3 kg to about 15 kg. Further, as indicated above, each of the components may be made of PETG. In such aspects, the components may be 3D-printed separately or, alternatively, together as a single unit. As will be appreciated, in aspects where the turbine 10 is 3D-printed as a single unit, components such as the interlocking arbors 34 and the screws 22 may not be required.

Further, although the turbines 10 of the present disclosure have been described mainly in relation to wind and water applications, it will be appreciated that the turbines may be used with other fluids as well.

### EXAMPLES

### Example 1

### Wind Speed Test Using Turbine Having a Blade Height of 20″ (508 mm)

A vertical axis turbine of according to an embodiment of the present disclosure having a blade height of 20″ (508 mm) was subjected to a wind speed test using the following procedure.

The turbine was connected to a 100 watt axial flux generator manufactured by Wind PMG, which in turn, was connected to an 85 A·h deep cycle 12V battery manufactured by Polar via a MPPT boost 12/24 model charge controller. The starting voltage of the battery was 11.79V.

The turbine and components connected thereto were installed in a wind tunnel having a 48″ (1219.2 mm) fan and a working flow cross-section of 1.03 m². Wind speeds inside the wind tunnel were monitored using a Model DT-8880 hot wire anemometer manufactured by CEM.

The wind speed in the wind tunnel was progressively increased. The turbine started spinning at wind speeds of 3 km/hr and started to charge the 12V battery at wind speeds of 10 km/hr (i.e. when the turbine reached 49 RPM). Once the battery started to charge, the wind speeds were maintained for 10 minutes. At the end of the 10-minute test, the battery voltage was 11.89V.

Thus, using the turbine in 10 km/hr winds for 10 minutes generated a voltage of 0.1V.

Example 2

### Wind Speed Test Using Turbine Have a Blade Height of 30″ (762 mm)

The procedure outlined in Example 1 was repeated with a vertical axis turbine of according to another embodiment of the present disclosure having a blade height of 30″ (762 mm), a 400 watt axial flux generator, and a 12V battery having a starting voltage of 11.89V.

The turbine started spinning at wind speeds of 1.5 km/hr and started to charge the 12V battery at wind speeds of 12 km/hr (i.e. when the turbine reaches 22 RPM). Once the battery started to charge, the wind speeds were maintained for 10 minutes. At the end of the 10-minute test, the battery voltage was 12.02V.

Thus, using the turbine in 12 km/hr winds for 10 minutes generated a voltage of 0.13V.

1. A vertical axis turbine comprising:
a turbine shaft;
a plurality of helicoidal blades mounted on the turbine shaft, each blade comprising a front face and a rear face; and
a plurality of venturis, each venturi comprising a channel extending through each of the plurality of blades from the front face thereof to the rear face thereof.

2. (canceled)

3. The vertical axis turbine of claim 1, wherein each of the plurality of blades comprises a plurality of stacked horizontal sections, each section being progressively rotated about a central point of the turbine in order to form a series of steps on the rear face of each of the plurality of blades.

4. The vertical axis turbine of claim 3, wherein each of the plurality of sections is rotated about 5° to about 10° relative to a section located immediately therebelow.

5. The vertical axis turbine of claim 4, wherein each of the plurality of sections is rotated about 9° relative to a section located immediately therebelow.

6. The vertical axis turbine of claim 3, wherein each of the plurality of sections is hook-shaped.

7. The vertical axis turbine of claim 3, wherein one or more of the plurality of sections is scalloped on a side forming the rear face of the each of the plurality of blades.

8. (canceled)

9. (canceled)

10. The vertical axis turbine of claim 1, wherein the channel of each of the plurality of venturis is a straight channel.

11. The vertical axis turbine of claim 1, wherein the channel of each of the plurality of venturis extends through each of the plurality of blades at an angle relative to the rear face of each of the plurality of blades.

12. The vertical axis turbine of claim 11, wherein the angle relative to the rear face of each of the plurality of blades is about 20° to about 60°.

13. The vertical axis turbine of claim 12, wherein the angle relative to the rear face of each of the plurality of blades progressively decreases from outermost venturis located adjacent an outer edge of each of the plurality of blades to innermost venturis located adjacent an inner edge of each of the plurality of blades.

14. The vertical axis turbine of claim 13, wherein the angle relative to the rear face of each of the plurality of blades progressively decreases by about 5°.

15. The vertical axis turbine of claim 14, wherein the angle relative to the rear face of the plurality of blades of the outermost venturis is about 50°.

16. The vertical axis turbine of claim 1, wherein the plurality of venturis comprises 30 venturis.

17. The vertical axis turbine of claim 1, wherein each of the plurality of blades further comprises a trailing edge.

18. (canceled)

19. The vertical axis turbine of claim 17, wherein each of the plurality of blades further comprises a shear line extending along a boundary where the trailing edge and the front face of each of the plurality of blades meet.

20. (canceled)

21. (canceled)

22. (canceled)

23. The vertical axis turbine of claim 1, wherein each of the plurality of blades further comprises a plurality of interlocking arbors extending from the rear face thereof for mounting the plurality of blades on the turbine shaft.

24. The vertical axis turbine of claim 23, wherein the plurality of interlocking arbors comprises 2 interlocking arbors.

25. (canceled)

26. (canceled)

27. (canceled)

28. (canceled)

29. (canceled)

30. (canceled)

31. The vertical axis turbine of claim 1, wherein the plurality of blades comprises 3 blades.
